(19) United States
(12) Patent Application Publication
(10) Pub. No.: US 2026/0145933 A1
(43) Pub. Date: May 28, 2026

(54) Controllable hydrogen production system and controllable hydrogen production method

(71) Applicant: Hoi Yan Serena CHENG, Hong Kong (HK)

(72) Inventor: Hoi Yan Serena CHENG, Hong Kong (HK)

(21) Appl. No.: 19/039,423

(22) Filed: Jan. 28, 2025

(30) Foreign Application Priority Data
Nov. 27, 2024 (CN) 202411714430.X

(51) Int. Cl. C01B 3/08; B01D 63/16; B01J 8/00; B01J 8/08; B01J 8/10; C01F 7/428

(52) U.S. Cl. CPC C01B 3/08; B01D 63/16; B01J 8/0045; B01J 8/006; B01J 8/085; B01J 8/10; C01F 7/428; B01J 2208/00769

(57) ABSTRACT

A controllable hydrogen production system and a controllable hydrogen production method. The controllable hydrogen production system includes a reactor, an aluminum conveying module, a sodium hydroxide conveying module, a water conveying module and a recovery module; the aluminum conveying module, the sodium hydroxide conveying module and the water conveying module communicate with the reactor, respectively; the reactor includes a first outlet and a second outlet, the recovery module includes a vibrating membrane filtration system, a first inlet of the vibrating membrane filtration system communicates with the first outlet of the reactor, the vibrating membrane filtration system further includes a third outlet, and the third outlet communicates with the reactor; the second outlet is used to convey generated hydrogen. The controllable hydrogen production method realizes efficient and controllable hydrogen production by using the controllable hydrogen production system and meanwhile recycles by-products and sodium hydroxide by using the vibrating membrane filtration system.

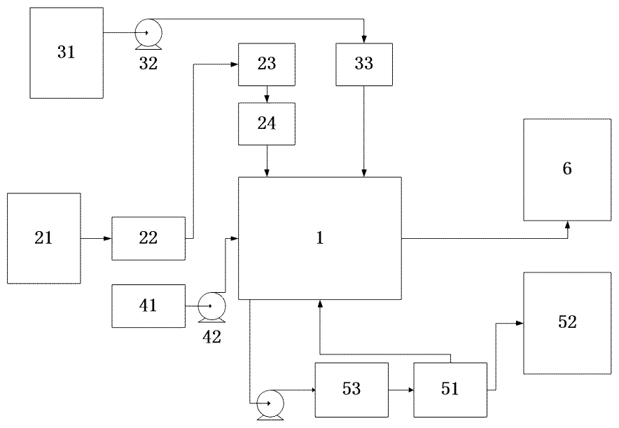

### TECHNICAL FIELD

The present invention relates to the field of hydrogen production through aluminum-water reaction and particularly to a controllable hydrogen production system and a controllable hydrogen production method.

### BACKGROUND ART

Due to the pressing global environmental problems, the proportion of renewable energy in global energy consumption is rising year by year. Hydrogen energy, characterized by zero carbon emissions and high energy density, is considered as an important clean energy option to promote sustainable development. However, the current mainstream hydrogen production methods, such as hydrogen production from fossil fuel, hydrogen production through biomass conversion and hydrogen production through water electrolysis, are facing challenges, such as low efficiency, high cost and environmental pollution. In addition, the storage and transport problems of hydrogen have long been the key factors restricting the wide application of hydrogen energy. Therefore, developing more efficient and environmentally friendly hydrogen production technology and solving the bottleneck of hydrogen storage and transport is crucial to promoting the further development of the hydrogen industry.

As a high-performance hydrogen storage material with high calorific value, aluminum can produce hydrogen in situ by reacting with water. This process is environmentally friendly and the product is recyclable. The high chemical activity of aluminum makes it easy to form a protective film at room temperature, which effectively solves the problems of its storage and transport. However, this property also requires specific means to activate the reaction between aluminum and water. At present, researchers mainly adopt various methods such as addition of an acid/alkali solution, alloying treatment, addition of an activator, high-temperature operation and preparation of ultra-fine aluminum powder to promote the activation of aluminum-water reaction, thereby significantly increasing the rate and total amount of hydrogen generation.

In the process of hydrogen production through aluminum-water reaction, some by-products are inevitably produced, such as aluminum hydroxide and partially reacted sodium hydroxide. These by-products are not fully utilized and treated, resulting in much waste of resources. In order to improve resource utilization and reduce environmental pollution, there is a need to explore effective ways to recover and recycle these by-products to achieve more efficient and environmentally friendly hydrogen production.

### SUMMARY OF THE INVENTION

A first objective of the present invention is to provide a controllable hydrogen production system to solve the existing problem that the by-products of the aluminum-water reaction for hydrogen production are not well utilized.

A second objective of the present invention is to provide a controllable hydrogen production method, which is realized by using the foregoing controllable hydrogen production system.

In order to achieve the first objective of the present invention, the present invention provides a controllable hydrogen production system. The controllable hydrogen production system comprises a reactor, an aluminum conveying module, a sodium hydroxide conveying module, a water conveying module and a recovery module; the aluminum conveying module, the sodium hydroxide conveying module and the water conveying module communicate with the reactor, respectively; the reactor is provided with a first outlet and a second outlet, the recovery module comprises a vibrating membrane filtration system, a first inlet of the vibrating membrane filtration system communicates with the first outlet of the reactor, the vibrating membrane filtration system further comprises a third outlet, and the third outlet communicates with the reactor; the second outlet is used to convey generated hydrogen.

As can be seen from the foregoing scheme, the present invention can activate the reaction of aluminum and water in the reactor at normal temperature and pressure through the aluminum conveying module, the sodium hydroxide conveying module and the water conveying module and can control the continuity and stop of the reaction by controlling the additive amounts of sodium hydroxide, aluminum and water, thereby achieving hydrogen production on demand and eliminating the complexity of transport and storage. Sodium hydroxide dissolves the oxide layer on the surface of aluminum, promoting the release of hydrogen. In addition, the present invention can effectively separate by-products such as aluminum hydroxide from the reaction liquid by providing a vibrating membrane filtration system using the micro-dynamic effect generated by the vibrating membrane. The separated by-products can be collected for other processes, and the reaction liquid containing sodium hydroxide can be recovered into the reactor for reuse, thereby maximizing resource utilization and economic benefits. The high shear force and high frequency vibration of the vibrating membrane help to prevent deposition and blockage of sediment on the membrane surface, thereby improving the separation efficiency and service life of the membrane. Compared with traditional methods that rely on precipitation and require a lot of time and space to treat by-products, the vibrating membrane filtration system enables continuous filtration and separation of by-products, thereby avoiding the need for sedimentation tanks, simplifying the process and realizing efficient recovery and utilization of by-products.

As a further scheme, the recovery module further comprises a concentrated by-product storage tank that communicates with a fourth outlet of the vibrating membrane filtration system.

As can be seen from the foregoing scheme, the use of a storage tank can effectively collect and store the by-products generated during the reaction process, prevent their loss, and ensure that the by-products will not cause harm to human and environment, and facilitate the recycling of resources.

As a further scheme, the recovery module further comprises a by-product dilution tank arranged between the first outlet of the reactor and the first inlet of the vibrating membrane filtration system.

As can be seen from the foregoing scheme, because the by-products produced in the reactor may have a high concentration or temperature, direct entry into the vibrating membrane filtration system may cause damage to the membrane material and reduce filtration efficiency and service life. The buffering effect of the dilution tank can effectively reduce the concentration and temperature of the by-products, making it more in line with the treatment requirements of the vibrating membrane filtration system. Further, the dilution tank also helps to improve the stability and reliability of the filtration system. During the dilution process, impurities and particulate matter in the by-products can be dispersed and settled to a certain extent, thereby reducing the risk of blocking the filtration system. Further, the diluted by-products can more easily pass through the vibrating membrane filtration system, improving the filtration efficiency and yield. Further, the dilution tank also plays a role in regulating and balancing the flow. Because the amount of by-products produced in the reactor may fluctuate, direct entry into the filtration system may result in deficiency or surplus of the treatment capacity. The storage and regulation functions of the dilution tank can ensure that the filtration system always operates at a stable flow rate, avoiding equipment damage or treatment efficiency drop caused by flow fluctuations. By optimizing the dilution ratio and filtration conditions, the recovery rate and purity of the by-products can be maximized.

As a further scheme, the aluminum conveying module comprises an aluminum storage tank, an aluminum conveyor, an aluminum buffer tank and a vibratory feeder, which are connected in turn, and the vibratory feeder communicates with the reactor.

As can be seen from the foregoing scheme, this scheme can effectively realize the transport of solid aluminum without pressure or heat input by providing an aluminum conveyor and a vibratory feeder, thereby reducing energy consumption and ensuring stable, controllable and efficient conveyance of aluminum to the reactor. The aluminum buffer tank plays a buffer role and prevents gas leakage in the reactor from contaminating the reactive materials in the aluminum storage tank.

As a further scheme, the aluminum conveyor is a screw conveyor.

As can be seen from the foregoing scheme, aluminum has different physical forms, such as powder, particle or small block, and the screw conveyor has good adaptability to these forms of material and can ensure the integrity and stability of the material and avoid losses in the conveying process. Further, the screw conveyor has a higher conveying efficiency than that of the traditional way, and can handle more materials per unit time. Still further, the structure of the screw conveyor is simple, making its installation, maintenance and repair relatively convenient. This reduces the maintenance cost of the equipment and ensures the long-term stable operation of the equipment, which helps to improve the overall production efficiency and reduce production cost. In addition, the design of the screw conveyor allows it to convey materials in horizontal, inclined and even vertical directions. This flexibility enables the screw conveyor to adapt to various complex production environments and ensures that aluminum can be successfully conveyed into the aluminum buffer tank. And the screw conveyor adopts closed conveyance, which can effectively prevent material leakage and dust, and avoid environmental pollution and health risks.

As a further scheme, the aluminum in the aluminum storage tank includes at least one of aluminum blocks, aluminum powder, aluminum particles, aluminum foil, aluminum slices, scrap aluminum chips and scrap aluminum cans.

As can be seen from the foregoing scheme, the aluminum in the present invention may be in a plurality of forms, has a wide range of applications, and promotes the recycling of aluminum waste.

As a further scheme, the sodium hydroxide conveying module comprises a sodium hydroxide solution tank, a first pressure pump and a sodium hydroxide buffer tank, which are connected in turn. A valve and a flow meter are arranged in the sodium hydroxide buffer tank, and the sodium hydroxide buffer tank is connected to the reactor.

As can be seen from the foregoing scheme, a valve and a flow meter are arranged in the sodium hydroxide buffer tank, can effectively control the amount of sodium hydroxide into the reactor, play a buffer role, and prevent the gas in the reactor from leaking into the sodium hydroxide solution tank and contaminating sodium hydroxide.

As a further scheme, a stirrer is arranged in the reactor, and the shell of the reactor is provided with a heat exchanger.

As can be seen from the foregoing scheme, the stirrer improves the mass transfer of the reactants by mixing the reaction substrate effectively, thereby facilitating the reaction. The stirrer can also increase the exchange rate between the reaction components to promote the mass transfer of the reaction components. The heat exchanger is mainly used to transfer heat between fluids to achieve the purpose of cooling, heating or temperature maintenance. By transferring heat to the reactants or reaction medium through the heat exchanger, the reaction conditions can be optimized and the reaction can be carried out more quickly and efficiently.

As a further scheme, the second outlet communicates with a hydrogen storage tank or a fuel cell.

As can be seen from the foregoing scheme, the hydrogen generated from the reaction can be used in different ways according to user's needs. If the user needs hydrogen, the hydrogen generated in the reactor can be pressurized by a compressor through the second outlet to the hydrogen storage tank. If the user needs electricity, the hydrogen generated in the Reactor Will Be Fed Into the Fuel Cell Through the Second Outlet and Converted into electricity.

In order to achieve the second objective of the present invention, the present invention provides a controllable hydrogen production method, which is realized by using a controllable hydrogen production system described in any of the foregoing schemes and comprises the following steps: S1: sodium hydroxide and water are conveyed into the reactor through the sodium hydroxide conveying module and the water conveying module, respectively, where they are made into a sodium hydroxide solution at a set concentration, which is 0.1% to 20%; S2: a set amount of aluminum is added to the reactor containing sodium hydroxide at the set concentration through the aluminum conveying system to carry out reaction; S3: the hydrogen generated from the reaction is conveyed out of the reactor through the second outlet of the reactor, the solution after the reaction enters the recovery module through the first outlet, and the vibrating membrane filtration system in the recovery module recovers by-products and recovers the sodium hydroxide solution into the reactor.

As can be seen from the foregoing scheme, the controllable hydrogen production method of the invention realizes efficient and controllable hydrogen production by using the controllable hydrogen production system and meanwhile recycles by-products and sodium hydroxide by using the vibrating membrane filtration system, thereby improving the utilization rate of resources.

### BRIEF DESCRIPTION OF THE DRAWINGS

The FIGURE is a process flow diagram of a controllable hydrogen production system of the present invention.

Below the present invention is further described by referring to the accompanying drawings and embodiments.

### DETAILED DESCRIPTION

As shown in the FIGURE, the controllable hydrogen production system in this embodiment comprises a reactor 1, an aluminum conveying module, a sodium hydroxide conveying module, a water conveying module and a recovery module.

The reactor 1 is provided with a first outlet and a second outlet. The first outlet communicates with the recovery module, and the second outlet communicates with a hydrogen collection module 6. The hydrogen collection module 6 comprises a hydrogen storage tank or a fuel cell. A stirrer is arranged in the reactor 1, and the shell of the reactor 1 is provided with a heat exchanger. The stirrer improves the mixing and mass transfer effects of the reactants, while the heat exchanger optimizes the reaction conditions through heat transfer.

The aluminum conveying module comprises an aluminum storage tank 21, an aluminum conveyor 22, an aluminum buffer tank 23 and a vibratory feeder 24, which are connected in turn. The vibratory feeder 24 communicates with the reactor 1. The aluminum in the aluminum storage tank 21 is in a plurality of forms, can be at least one of aluminum blocks, aluminum powder, aluminum particles, aluminum foil, aluminum slices, scrap aluminum chips and scrap aluminum cans, has a wide range of applications, and promotes the recycling of aluminum waste. Preferably, the aluminum conveyor 22 is a screw conveyor. The screw conveyor has good adaptability to various forms of aluminum and can ensure the integrity and stability of the material and avoid losses in the conveying process. Further, the screw conveyor also has many advantages, such as improving the overall production efficiency, reducing production cost, adapting to a plurality of transport environments, and avoiding environmental pollution and health risks. The provision of the aluminum conveyor 22 and the vibratory feeder 24 can effectively realize the transport of solid aluminum without pressure or heat input, reduce energy consumption and ensure stable, controllable and efficient conveyance of aluminum to the reactor 1. The aluminum buffer tank 23 plays a buffer role and prevents gas leakage in the reactor 1 from contaminating the reactive materials in the aluminum storage tank 21.

The sodium hydroxide conveying module comprises a sodium hydroxide solution tank 31, a first pressure pump 32 and a sodium hydroxide buffer tank 33, which are connected in turn. A valve and a flow meter are arranged in the sodium hydroxide buffer tank 33, and the sodium hydroxide buffer tank 33 is connected to the reactor 1. The valve and the flow meter can effectively control the amount of sodium hydroxide into the reactor, play a buffer role, and prevent the gas in the reactor 1 from leaking into the sodium hydroxide solution tank 31 and contaminating sodium hydroxide.

The water conveying module comprises a water storage tank 41 and a second pressure pump 42. Water in the water storage tank 41 is conveyed into the reactor 1 through the second pressure pump 42.

The recovery module comprises a vibrating membrane filtration system 51, a concentrated by-product storage tank 52 and a by-product dilution tank 53. The vibrating membrane filtration system 51 comprises a first inlet, a third outlet and a fourth outlet. The first inlet communicates with the first outlet of the reactor 1, the third outlet communicates with the reactor 1, and the fourth outlet communicates with the concentrated by-product storage tank 52. The by-product dilution tank 53 is arranged between the first outlet of the reactor 1 and the first inlet of the vibrating membrane filtration system 51. The vibrating membrane filtration system 51 can effectively separate by-products such as aluminum hydroxide from the reaction liquid by using the micro-dynamic effect generated by the vibrating membrane and store them in the concentrated by-product storage tank 52 to realize recycling of resources. The reaction liquid containing sodium hydroxide can be recovered into the reactor 1 for reuse, thereby maximizing resource utilization and economic benefits. The high shear force and high frequency vibration of the vibrating membrane help to prevent deposition and blockage of sediment on the membrane surface, thereby improving the separation efficiency and service life of the membrane. Because the by-products produced in the reactor 1 may have a high concentration or temperature, direct entry into the vibrating membrane filtration system 51 may cause damage to the membrane material and reduce filtration efficiency and service life. The buffering effect of the dilution tank 53 can effectively reduce the concentration and temperature of the by-products, making it more in line with the treatment requirements of the vibrating membrane filtration system 51. Further, the by-product dilution tank 53 also has many functions, such as improving the stability and reliability of the vibrating membrane filtration system 51, reducing blocking, balancing flow, increasing the recovery rate and purity of by-products and improving filtration efficiency and yield.

By using the controllable hydrogen production system of this embodiment, a controllable hydrogen production method can be realized, which comprises the following steps:
S1: sodium hydroxide and water are conveyed into the reactor 1 through the sodium hydroxide conveying module and the water conveying module, respectively, where they are made into a sodium hydroxide solution at a set concentration, which is 0.1% to 20%;
S2: a set amount of aluminum is added to the reactor 1 containing sodium hydroxide at the set concentration through the aluminum conveying system to carry out reaction;
S3: the hydrogen generated from the reaction is conveyed out of the reactor through the second outlet of the reactor 1, the solution after the reaction enters the recovery module through the first outlet, and the vibrating membrane filtration system 51 in the recovery module recovers by-products and recovers the sodium hydroxide solution into the reactor.

In the controllable hydrogen production system of this embodiment, a pressure sensor, a temperature sensor, a pH sensor, a liquid level sensor and other sensors can also be arranged, too, and through an external control system and the information of various sensors, the opening and closing of the valves between tanks and devices, the stirrer and the heat exchanger can be controlled, thereby realizing the automatic control of the entire hydrogen production process and making the hydrogen production process more efficient and controllable.

The controllable hydrogen production system of this embodiment can realize a controllable hydrogen production method, activate the reaction of aluminum and water in the reactor 1 at normal temperature and pressure through the aluminum conveying module, the sodium hydroxide conveying module and the water conveying module, and control the continuity and stop of the reaction by controlling the additive amounts of sodium hydroxide, aluminum and water, thereby achieving hydrogen production on demand and eliminating the complexity of transport and storage. Sodium hydroxide dissolves the oxide layer on the surface of aluminum, promoting the release of hydrogen. The vibrating membrane filtration system 51 ensures the recovery of valuable aluminum hydroxide and sodium hydroxide and helps to realize a closed-loop and sustainable processes. With the aluminum conveyor 22 and the vibratory feeder 24, solid aluminum in various forms can be effectively transported without pressure or heat input, has a wide range of applications, and promotes the recycling of aluminum waste. The hydrogen collection module 6 can be a hydrogen storage tank or a fuel cell, and achieve different applications of hydrogen according to user's needs. If the user needs hydrogen, the hydrogen generated in the reactor 1 can be pressurized by a compressor through the second outlet to the hydrogen storage tank. If the user needs electricity, the hydrogen generated in the reactor will be fed into the fuel cell through the second outlet and converted into electricity.

Lastly, it should be noted that the above description is only preferred embodiments of the present invention and is not intended to limit the present invention, and for those skilled in the art, the present invention may have various changes and modifications, and all modifications, equivalent replacements and improvements made within the spirit and principle of the present invention shall be within the scope of protection of the present invention.

1. A controllable hydrogen production system, wherein the controllable hydrogen production system comprises:
a reactor, an aluminum conveying module, a sodium hydroxide conveying module, a water conveying module and a recovery module; the aluminum conveying module, the sodium hydroxide conveying module and the water conveying module communicate with the reactor, respectively;
the reactor is provided with a first outlet and a second outlet, the recovery module comprises a vibrating membrane filtration system, a first inlet of the vibrating membrane filtration system communicates with the first outlet of the reactor, the vibrating membrane filtration system further comprises a third outlet, and the third outlet communicates with the reactor;
the second outlet is used to convey generated hydrogen.

2. The controllable hydrogen production system according to claim 1, wherein:
the recovery module further comprises a concentrated by-product storage tank that communicates with a fourth outlet of the vibrating membrane filtration system.

3. The controllable hydrogen production system according to claim 1, wherein:
the recovery module further comprises a by-product dilution tank arranged between the first outlet of the reactor and the first inlet of the vibrating membrane filtration system.

4. The controllable hydrogen production system according to claim 1, wherein:
the aluminum conveying module comprises an aluminum storage tank, an aluminum conveyor, an aluminum buffer tank and a vibratory feeder, which are connected in turn, and the vibratory feeder communicates with the reactor.

5. The controllable hydrogen production system according to claim 4, wherein:
the aluminum conveyor is a screw conveyor.

6. The controllable hydrogen production system according to claim 4, wherein:
the aluminum in the aluminum storage tank includes at least one of aluminum blocks, aluminum powder, aluminum particles, aluminum foil, aluminum slices, scrap aluminum chips and scrap aluminum cans.

7. The controllable hydrogen production system according to any of claim 1, wherein:
the sodium hydroxide conveying module comprises a sodium hydroxide solution tank, a first pressure pump and a sodium hydroxide buffer tank, which are connected in turn, a valve and a flow meter are arranged in the sodium hydroxide buffer tank, and the sodium hydroxide buffer tank is connected to the reactor.

8. The controllable hydrogen production system according to any of claim 1, wherein:
a stirrer is arranged in the reactor, and the shell of the reactor is provided with a heat exchanger.

9. The controllable hydrogen production system according to any of claim 1, wherein:
the second outlet communicates with a hydrogen storage tank or a fuel cell.

10. A controllable hydrogen production method, wherein the controllable hydrogen production method is realized by using a controllable hydrogen production system described in claim 1 and comprises the following steps:
S1: sodium hydroxide and water are conveyed into the reactor through the sodium hydroxide conveying module and the water conveying module, respectively, where they are made into a sodium hydroxide solution at a set concentration, which is 0.1% to 20%;
S2: a set amount of aluminum is added to the reactor containing sodium hydroxide at the set concentration through the aluminum conveying system to carry out reaction;
S3: the hydrogen generated from the reaction is conveyed out of the reactor through the second outlet of the reactor, the solution after the reaction enters the recovery module through the first outlet, and the vibrating membrane filtration system in the recovery module recovers by-products and recovers the sodium hydroxide solution into the reactor.
